(19) United States
(12) Patent Application Publication
(10) Pub. No.: US 2013/0318445 A1
(43) Pub. Date: Nov. 28, 2013

(54) USER INTERFACES BASED ON POSITIONS

(71) Applicants: April Slayden Mitchell, San Jose, CA (US); Mark C. Solomon, San Diego, CA (US); Glenn A. Wong, Foster City, CA (US); Susie Wee, Palo Alto, CA (US); Qi-Bin Sun, Shanghai (CN)

(72) Inventors: April Slayden Mitchell, San Jose, CA (US); Mark C. Solomon, San Diego, CA (US); Glenn A. Wong, Foster City, CA (US); Susie Wee, Palo Alto, CA (US); Qi-Bin Sun, Shanghai (CN)

(21) Appl. No.: 13/981,151

(22) PCT Filed: Feb. 28, 2011
(86) PCT No.: PCT/CN2011/000316

§ 371 Date: Jul. 23, 2013

(51) Int. Cl. G06F 3/048

(52) U.S. Cl. CPC G06F 3/048
USPC 715/744

(57) ABSTRACT

Example embodiments disclosed herein relate to user interface presentation based on position information. A position of a user of a multi-user interface is detected. A portion of the multi-user interface is provisioned for the user based on the position.

### BACKGROUND

Large interactive displays may be geared towards various users. A large interactive display can include one or more displays or presentation devices such as a monitor or multiple monitors. Due to their size, large interactive displays are well-suited for interacting with multiple users. Device manufacturers of such large interactive displays are challenged to provide new and compelling user experiences for the large interactive displays.

### BRIEF DESCRIPTION OF THE DRAWINGS

The following detailed description references the drawings, wherein:

FIG. 1 is a block diagram of a computing device including instructions for customizing user interfaces, according to one example;

FIGS. 2A and 2B are block diagrams of devices to customize user interfaces, according to various examples;

FIG. 3 is a flowchart of a method for providing a multi-user interactive display, according to one example;

FIG. 4 is a flowchart of a method for customizing user interfaces based on position information, according to one example;

FIG. 5 is a flowchart of a method for providing user interfaces to users based on zones, according to one example;

FIG. 6 is a flowchart of a method for automatically providing user interface to a user, according to one example; and

FIG. 7 is a block diagram of a system for utilizing a multi-user interactive user interface, according to one example.

### DETAILED DESCRIPTION

Multi-user interfaces can be utilized to provide information to users as well as to generate information. In certain embodiments, a multi-user interface is a mechanism to provide interactive content to multiple users. For example, one user can utilize the user interface or many users can utilize the user interface concurrently. An example of a multi-user interface includes a large interactive device (LID). A LID can include a large interactive display and can be a device or system including multiple devices that allows for user input to be received from multiple users and content to be presented simultaneously to multiple users. In certain embodiments, a large interactive display is a display large enough to allow multiple users to interact with it at the same time. Further, in certain embodiments, large interactive displays have large display surfaces, which can be a single large display, a number of tiled smaller displays, or the like. Large interactive displays can include interactive projection displays (e.g., a display to a projection screen or wall), liquid crystal displays (LCDs), etc. Examples of ways to interact with a multi-user interface are via a touch mechanism, such as pointing via a finger, a pen or stylus mechanism, multi-touch enabled input, an audible input mechanism (e.g., voice), and a gesture mechanism.

Multi-user interfaces can be utilized in collaborations to generate content (e.g., via a digital white board). Further, multi-user interfaces can be utilized to present content to users in a building lobby (e.g., a directory, a map, etc.) during a meeting (e.g., agenda, attendees, etc.), or in a classroom.

Users may want to expand their interactions with the multi-user interface. A user may wish to interact with the interface from various locations, for example, from a close proximity where the user can touch the display, to farther away where the user may need to utilize another type of input mechanism. Further, it may be useful for the user to utilize a dynamic user interface that can customize the interface and/or input mechanism schemes available to the user based on position and/or distance. Accordingly, various embodiments disclosed herein relate to customizing user interfaces based on position information.

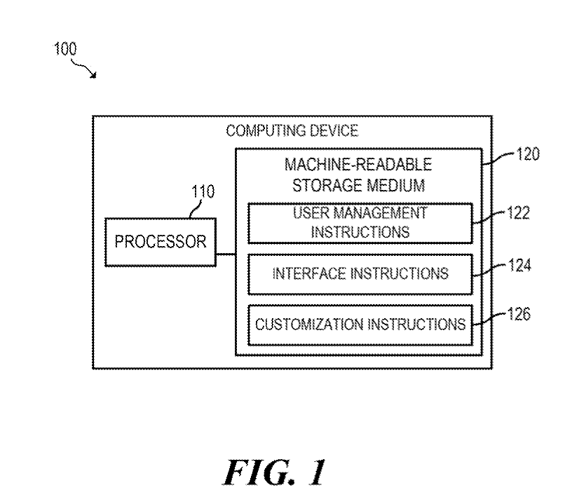

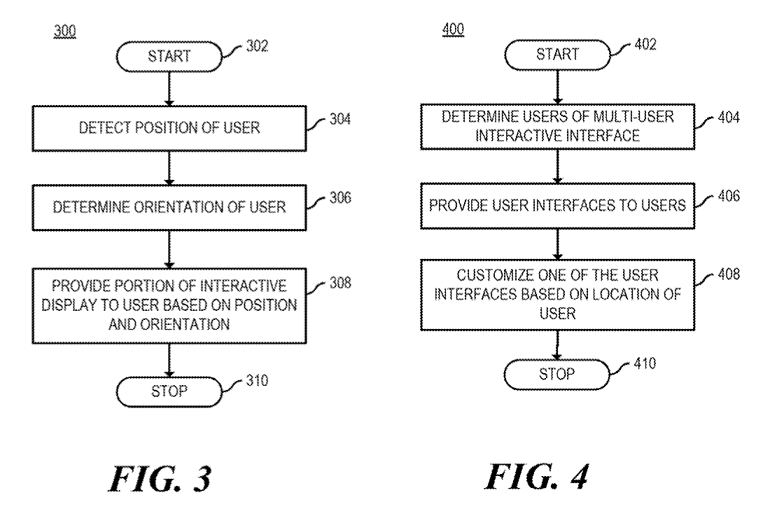

FIG. 1 is a block diagram of a computing device including instructions for customizing use interfaces, according to one example. The computing device 100 includes, for example, a processor 110, and a machine-readable storage medium 120 including instructions 122, 124, 126 for customizing user interfaces for users. Computing device 100 may be, for example, a chip set, a notebook computer, a slate computing device, a portable reading device, a wireless email device, a mobile phone, or any other device capable of executing the instructions 122, 124, 126. In certain examples, the computing device 100 may be connected to additional devices such as sensors, displays, etc. to implement the processes of FIGS. 3-6.

Processor 110 may be, at least one central processing unit (CPU), at least one semiconductor-based microprocessor, at least one graphics processing unit (GPU), other hardware devices suitable for retrieval and execution of instructions stored in machine-readable storage medium 120, or combinations thereof. For example, the processor 110 may include multiple cores on a chip, include multiple cores across multiple chips, multiple cores across multiple devices (e.g., if the computing device 100 includes multiple node devices), or combinations thereof. Processor 110 may fetch, decode, and execute instructions 122, 124, 126 to implement customization, of user interfaces. As an alternative or in addition to retrieving and executing instructions, processor 110 may include at least one integrated circuit (IC), other control logic, other electronic circuits, or combinations thereof that include a number of electronic components for performing the functionality of instructions 122, 124, 126.

Machine-readable storage medium 120 may be any electronic, magnetic, optical, or other physical storage device that contains or stores executable instructions. Thus, machine-readable storage medium 120 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail below, machine-readable storage medium 120 may be encoded with a series of executable instructions for customizing user interfaces and presentations based on position information.

Moreover, the instructions 122, 124, 126, when executed by a processor (e.g., via one processing element or multiple processing elements of the processor) can cause the processor to perform processes, for example, the processes of FIG. 3-FIG. 6. For example, user management instructions 122 can be utilized to cause the processor 110 to determine users of a multi-user interactive interface. The interface instructions 124 can be executed by the processor 110 to change the interface, for example, by outputting a signal to control an associated display (e.g., a LID). The interface can be displayed via a presentation device such as an LCD, a projector, etc. The interface instructions 124 can thus be utilized to modify the content shown on the display.

The user management instructions 122 may determine the users by using input. For example, facial recognition, a user name and/or password, voice input, sensor input, or the like can be utilized to determine a current user. The processor 110 receives the input information including information describing a user. The input information can include, for example, visual information (e.g., via a camera sensor, etc.), audio information (e.g., via a microphone), touch information (e.g., via an infrared sensor), gesture information (e.g., via a proximity sensor), or the like. Sensor inputs can be processed to determine a position of the user. For example, visual sensors or audio sensors can be utilized to triangulate the position of a user. Moreover, an orientation of the user can be determined using the sensors. For example, feature tracking, voice localization, etc. can be utilized to determine the orientation of the user. The orientation and/or position information can be utilized to determine a portion of the interface to customize for the user. For example, the presentation information can be placed in a portion of the display where the user is looking.

Customization instructions 126 can be utilized to customize a portion of the interface associated with the user based on the user's location. In certain scenarios, the interface is utilized by multiple users. As such, a portion of the interface may be determined for the user based on the user's position in front of the display, the user's distance from the display, the user's orientation, or combinations thereof. The customization instructions 126 can be utilized to determine the portion of the interface for a particular user and the interface instructions 124 can be utilized to present the interface near the user's location.

In one example, the size and/or location of the interface portion are customized based on location information of the user. In various embodiments, location information includes a position, an orientation, a distance of the user from a reference point (e.g., a sensor, the display, etc.), or a combination thereof. In certain examples, a user interface portion is a part of the display that is allocated for use with the user and/or session. The user interface portion can include one or more user interface elements. By way of example, user interface elements can include images, text (e.g., based on one or more fonts), windows, menus, icons, controls, widgets, tabs, cursors, pointers, etc. The portion may be larger if it is determined that the user is farther away. Further, user interface elements within the allocated portion can be scaled, and/or moved based on the position and/or orientation of the user. In one example, if the user changes position and/or orientation to another area associated with the LID, the portion of the user interface may be customized based on the change. For example, if the user walks to another section of the presentation, the portion can be moved to the section. In certain examples, the change in position of the portion can be based on a trigger (e.g., a voice command, another input, a determination that the user has moved a threshold distance, a determination that the user has moved for a threshold time period, combinations thereof, etc.). Further, the trigger can be determined without user interaction.

Additionally or alternatively, an input type associated with the user can be based on the position, and/or orientation of the user. The input type can be determined based on the location of the user compared to the display, for example as detected by a proximity sensor. Examples of input types include a touch enabled interface (e.g., a surface acoustic wave technology, resistive touch technology, capacitive touch technology, infrared touch technology, dispersive signal technology, acoustic pulse recognition technology, other multi-touch technologies, etc.), a gesture interface (e.g., based on an input sensor tracking the user), an audio interface (e.g., based on an audio sensor such as a microphone), a video interface (e.g. based on image sensors and tracking instructions that can be executed by the processor 110), and a remote device (e.g., a mouse, a keyboard, a phone, etc.).

Further, customization of user interfaces to users can be based on zones. A zone can be an area or volume of space that can be determined by sensors that can be associated with users. Zones can be predetermined and stored in a data structure associated with the computing device 100. Users can be associated with the zones depending on the users' respective position. When it is determined that a user is within a particular zone, the customization instructions may be utilized to generate a custom user interface for the user based on the particular zone. This may include, for example, portion of interface sizing, input type determinations, portion of interface placement, user interface element sizing/scaling, user interface element placement, etc.

Additionally, when a user changes zones, the processor 110 can determine that the user has changed zones. Further customization of the user interface or a particular portion of the user interface associated with the user can be performed based on the change in zone. For example, the portion of the interface and/or user interface elements associated with the portion can be resized/rescaled to a predetermined size associated with the zone. The portion of the interface and/or user interface elements can further be customized based on a user profile associated with the user. The user profile may include, for example, preferences as to what size and/or input types should be activated when the user is in a particular zone. For example, the size of the portion of the interface and/or user interface elements can be larger when the user moves to a zone farther away from a display including the portion or smaller when the user moves to the display. Moreover, user management instructions 122 can be utilized to determine the number of users in a particular zone. The amount of portions active in a zone can be utilized to further customize the presentation and/or user inputs.

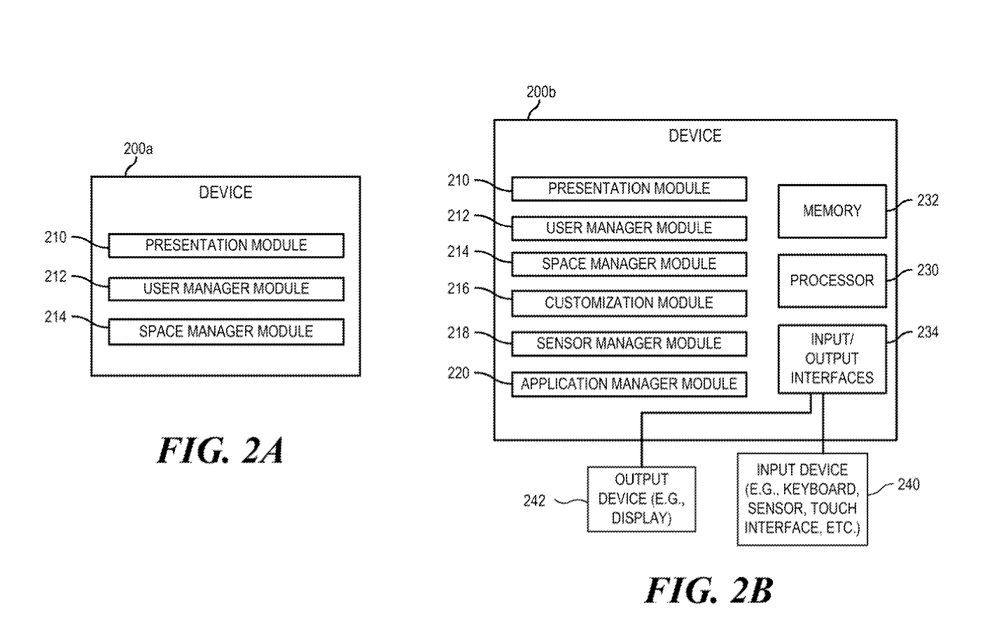

FIGS. 2A and 28 are block diagrams of devices to customize user interfaces, according to various examples. Devices 200a, 200b include modules that can be utilized to customize a multi-user interactive user interface for a user. The respective devices 200a, 200b may be a notebook computer, a slate computing device, a portable reading device, a wireless device, a large interactive display, a server, a smart wall, or any other device that may be utilized to customize a multi-user user interface. A processor, such as a CPU, a GPU, or a microprocessor suitable for retrieval and execution of instructions and/or electronic circuits configured to perform the functionality of any of the modules 210-220 described below. In some embodiments, the devices 200a, 200b can include some of the modules (e.g., modules 210-214), the modules (e.g., modules 210-220) shown in FIG. 2B, and/or additional components.

As detailed below, devices 200a, 200b may include a series of modules 210-220 for customizing user interfaces. Each of the modules 210-220 may include, for example, hardware devices including electronic circuitry for implementing the functionality described below. In addition or as an alternative, each module may be implemented as a series of instructions encoded on a machine-readable storage medium of respective devices 200a, 200b and executable by a processor. It should be noted that, in some embodiments, some modules 210-220 are implemented as hardware devices, while other modules are implemented as executable instructions.

A presentation module 210 can be utilized to present interfaces to users. The presentation module 210 can determine interface elements and transmit these elements to a presentation device, such as a display, a projector, a monitor (e.g., an LCD), a television, etc. Further, in certain examples, the presentation module 210 can include the presentation device (e.g., a large interactive display). In this manner, the presentation module 210 can be utilized to present a multi-user interface to users.

A user manager module 212 can be utilized to determine users of the respective device 200a, 200b. For example, a user can be identified by processing information collected by sensors or other input mechanisms. A user profile can be associated with the user and may be customized based on user preferences. Further, an identifier of the user can be stored with the user profile. For example, the identifier can include information that may be utilized to determine the user from sensor information. In certain examples, the identifier can include facial recognition, a mechanism to tag the user (e.g., utilizing a particular color associated with the user), voice analysis, or the like.

Users determined by the user manager module 212 can be associated with a zone by a space manager module 214. The space manager module 214 can determine zones associated with the respective devices 200a, 200b. The zones can be individualized to the devices 200a, 200b, and/or surroundings (e.g., a room) associated with the devices 200a, 200b. For example, a large display may include more zones than a small display. A portion of the multi-user interface may be customized for the user based on the zone.

In one example, the user manager module 212 determines the position of the user is within a particular zone. The space manager module 214 then determines a portion of the multi-user interface for the user based on the location of the zone. The size of the portion of the interface can be determined based on the distance of the user from a reference face (e.g., display) or reference point (e.g., sensor location) associated with the display. Thus, a relationship of the user's position, reflected by the zone, can be utilized to customize the user interface portion. Further, if the user manager module 212 determines additional users in the zone, the presentation module 210 can present the user interface portion based on the additional users. For example, additional users in a particular zone may be utilized to modify the portion. In this example, if there are two users in the zone, the portion allotted to the user may be larger than if there are three users in the zone. Moreover, the space manager module 214 can manage the space of the multi-user interactive user interface among various users, applications, and/or services. As such, the space manager module 214 may dynamically adapt the usage of space depending on users.

As shown in device 200b, a customization module 216 can be utilized to customize an input type of the user interface portion based on the zone. Additionally or alternatively, the customization can be based on the location (position, distance, and/or orientation) of the user. The location of the user can be determined based on information gathered by sensors.

A sensor manager module 218 gathers the information from the sensors and provides the information (e.g., position information, orientation information, distance information from a reference point or sensor, etc.) to the user manager module 212, space manager module 214, customization module 216, or other components of the device 200b. The sensor manager module 218 can utilize a processor 230 to store the information in a memory 232 that can be accessed by other modules of the device 200b. Further, the sensor manager module 218 can utilize input/output interfaces 234 to obtain the sensor information from an input device 240. In certain scenarios, an input device 240 can include a sensor, a keyboard, a mouse, a remote, a keypad, or the like. Sensors can be used to implement various technologies, such as infrared technology, touch screen technology, etc.

The device 200b may include devices utilized for input and output (not shown), such as a touch screen interface, a networking interface (e.g., Ethernet), a Universal Serial Bus (USB) connection, etc. The presentation module 210 can additionally utilize input/output interfaces 234 to output the presentation, for example, on a display, via a projector, or the like. Such a presentation can be geared towards multiple users (e.g., via a large interactive multi-user display, an interactive wall presentation, interactive whiteboard presentation, etc.).

An application manager module 220 can manage applications and/or services that can be used through the device 200b. Some applications may be used by different users and may be allocated to a specific portion of the multi-user interactive user interface. Other applications may be presented across multiple portions and/or to a public area of the multi-user interactive user interface. As such, the application manager module 220 can determine information for the user or multiple users of the device 200b. The information can include electronic mail information, messaging information (e.g., instant messenger messages, text messages, etc.), control information, tool panel information (e.g., a color palate, a drawing tool bar, a back button on a browser, etc.), property information (e.g., attributes of content such as a video), calendar information (e.g., meeting information), or the like.

The presentation module 210 can present the portion of the interface based on the information. For example, a message can be determined by the application manager module 220 to be associated with the user. The user manager module 212 is then utilized to determine that the user is using the device 200b. The sensor manager module 218 provides information to determine a portion of the interface provided to the user via the space manager module 214. The message can then be provided in front of the user. To determine where to provide the portion of the interface, the space manager module 214 determines a focus of the user based on the sensor information. The portion can be determined based on location information (e.g., a determined intersection of a vector created by the position, orientation, and distance of the user with a face of a display associated with the device 200b).

In another example, a user may be utilizing an image creation application. The user may request a toolbar, palate, control information, etc. to utilize. The request can be, for example, via a voice command. When the voice command is processed, the orientation of the user can be determined and the requested information or tool can be displayed on the interface at the appropriate location as determined by the space manager module 214.

FIG. 3 is a flowchart of a method for providing a multi-user interactive display, according to one example. Although execution of method 300 is described below with reference to computing device 100, other suitable components for execution of method 300 can be utilized (e.g., device 200a, 200b). Thus, the devices 100, 200a, 200b can be considered means for implementing method 300 or other processes disclosed herein. Additionally, the components for executing the method 300 may be spread among multiple devices (e.g., a processing device in communication with input and output devices). In certain scenarios, multiple devices acting in coordination can be considered a single device to perform the method 300. Method 300 may be implemented in the form of executable instructions stored on a machine-readable storage medium, such as storage medium 120, and/or in the form of electronic circuitry.

Method 300 may start at 302 and proceed to 304, where computing device 100 may detect a location of a user of a multi-user interactive display. As previously noted, the multi-user interactive display can be a digital whiteboard, a smart wall, or the like. The position can be determined from collected sensor information (e.g., based on infrared technology, camera technology, etc.).

Further, at 306, an orientation of the user is determined based on sensor information. In certain scenarios, the orientation can be determined based on an identification of features of the user (e.g., facial information, voice detection, etc.). Moreover, orientation can be in relation to one or more reference points (e.g., sensor locations) or a reference face (e.g., a display side) of the presentation. For example, a user's position and orientation can be correlated with a known reference point or face of the display to determine where on the display the user is looking.

Then, at 308, the computing device 100 customizes a portion of the multi-user interactive display for the user based on the user's location. The portion can be a geometrical figure such as a square, a bounded area, or the like. Further, multiple portions can be associated with a single user (e.g., each portion associated with a different user interface element or application). In one example, the portion is sized based on the position of the user. For example, if the user is within a threshold distance of the display, it may be beneficial to provision a smaller sized portion for the user because the user may not be able to easily see a larger portion due to the user's closeness to the display. In another example, if the user is farther away, it can be more useful to provision a larger portion of the interface, which can include user interface elements scaled in a like manner so that the user can more easily view content being presented.

Further, the interface can be customized based on the user's location. For example, an input type or multiple input types can be provided to the user based on the position, distance, and/or orientation of the user. In one example, a gesture interface can be used to interact with the computing device 100 if the user is away from the display while a touch interface may be used to interact with the computing device 100 if the user is closer to the display. In certain examples, the position information may be compared to a profile of the user to determine what types of input interfaces to provide to the user. In some scenarios, the interface can be implemented so that the user can limit interactions with his/her portion of the interface. In other scenarios, the user may trigger a mode (e.g., via an audio or gesture interface) that allows other users to interact with his/her portion of the interface.

In certain examples, as the user moves around, the computing device 100 is able to perform blocks 304, 306, and 308 based on another position, distance, and/or orientation of the user. As such, another location is determined. Another portion of the presentation can be determined based on the new location. The other portion of the interface can then be accessible to the user. In this manner, the information presented on the first portion can be displayed at the second portion. Additionally, the user interface associated with the second portion can be customized for the location of the user.

In other examples, another user of the presentation can be detected. The computing device 100 is also able to perform blocks 304, 306, and 308 for the other user. The location of the other user is detected. Based on this information, the computing device 100 provides another portion of the multi-user interactive display to the other user as another user interface. Then, at 310, the process 300 stops.

FIG. 4 is a flowchart of a method for customizing user interfaces based on position information, according to one example. Although execution of method 400 is described below with reference to computing device 100, other suitable components for execution of method 400 can be utilized (e.g., device 200a, 200b). Additionally, the components for executing the method 400 may be spread among multiple devices (e.g., a processing device in communication with input and output devices). In certain scenarios, multiple devices acting in coordination can be considered a single device to perform the method 400. Method 400 may be implemented in the form of executable instructions stored on a machine-readable storage medium, such as storage medium 120, and/or in the form of electronic circuitry.

Method 400 may start at 402 and proceed to 404, where computing device 100 determines users of a multi-user interactive user interface. The determination can be based on sensor information that can be processed to determine the identities of users. The sensor information can additionally be utilized to determine the position, distance, and/or orientation of the users. This can be based on multiple technologies being implemented, for example, a camera technology. Further, the determination can be based on a single type of technology, such as proximity sensors to determine the position and/or movements of the users.

At 406, the computing device 100 generates interfaces respectively associated with the users. Further, the computing device 100 may provide interfaces unassociated with a particular user. The provisioning can be via a determination of what part of the multi-user interface is associated with the user.

Then, at 408, the computing device 100 customizes one of the user interfaces respectively associated with one of the users based on a location of the user. As previously noted, the user interface can be customized based on a zone associated with the user. Further, customization can include determination of the size of the user interface respectively associated with the user. Additionally, customization can include a determination of an input type for the user based on the location (e.g., in comparison with another location associated with the display, such as the location of a sensor). The user input type can include at least one of a touch enabled interface, a gesture interface, an audio interface, a video interface, and a remote device.

Additionally, changes in the user's location can be utilized to trigger additional customization. For example, a user's change in location can be utilized to provision another portion of the interface for the user or to increase the size of the portion of the interface. Further, if more space on the display is unavailable, the interface may be augmented to increase the size of particular interface elements, such as fonts, images, or the like, within the allocated portion of the interface. Then, at 410, the process 400 stops.

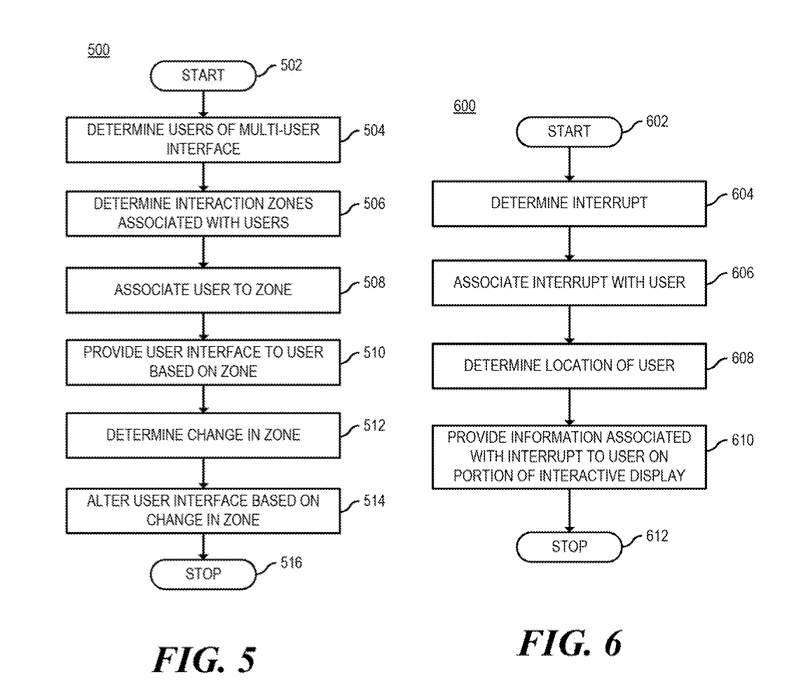

FIG. 5 is a flowchart of a method for providing interfaces to users based on zones, according to one example. Although execution of method 500 is described below with reference to device 200b, other suitable components for execution of method 500 can be utilized (e.g., computing device 100 or device 200a). Additionally, the components for executing the method 500 may be spread among multiple devices (e.g., a processing device in communication with input and output devices). In certain scenarios, multiple devices acting in coordination can be considered a single device to perform the method 500. Method 500 may be implemented in the form of executable instructions stored on a machine-readable storage medium or memory 232, and/or in the form of electronic circuitry.

Method 500 may start in 502 and proceed to 504, where device 200b may determine users of a multi-user interactive user interface. Users may be determined based on reception of input at the device 200b, for example, via an input device 240. Examples of inputs that may be utilized to determine the users include radio-frequency identification, login input, voice or facial recognition information, or the like. Further, once a user is determined, other information collected by a sensor manager module 218 can be utilized to monitor any changes in the location of the user.

At 506, a space manager module 214 determines interaction zones. The interaction zones can be determined from a data structure, for example, a data structure describing the interaction zones stored in memory 232. Further, the space manager module 214 may determine the zones based on sensor information of an area surrounding the device 200b or a location associated with the multi-user interface. Then, at 508, one of the users is associated with one of the zones. The association can be based on a position mapping of the user to the zone.

At 510, the space manager module 214 allocates and the presentation module 210 presents a portion of the interface for the user based on the zone. The customization can include determining a size or scaling of the user interface portion based on the zone. For example, the size or scaling can be proportional to the distance from the presentation. Further, the customization can be based on the number of users determined to be within the same zone or a corresponding zone. Thus, the space manager module 214 can provide the portion based on availability of space at the multi-user interface. Moreover, customization may include customization of an input type associated with the interface portion based on the zone.

Then, at 512, a change in zone of the user is determined. This can be determined based on sensor information indicating that the user has left a first zone and moved to another zone. This can be determined based on assigning a coordinate or set of coordinates to the user based on the sensor information and aligning zone boundaries to coordinate portions. At 514, the interface portion is altered based on the change in zone. The alteration can be accomplished by changing the input type, by changing the size of the portion, by moving the portion to another location based on the current location of the user, or the like. At 516, the method 500 comes to a stop.

FIG. 6 is a flowchart of a method for automatically providing a customized interface to a user, according to one example. Although execution of method 600 is described below with reference to device 200b, other suitable components for execution of method 600 can be utilized (e.g., computing device 100 or device 200a). Additionally, the components for executing the method 600 may be spread among multiple devices (e.g., a processing device in communication with input and output devices). In certain scenarios, multiple devices acting in coordination can be considered a single device to perform the method 600. Method 600 may be implemented in the form of executable instructions stored on a machine-readable storage medium or memory 232, and/or in the form of electronic circuitry.

Method 600 may start at 602 and proceed to 604, where device 200b may determine an interrupt. The interrupt can be caused by a module of the device 200b, such as the application manager module 220. The interrupt can be associated with content information as well as with a user. For example, an incoming e-mail for a user can cause an interrupt, which results in an indication that a new e-mail is ready for the users viewing. Further, a calendar entry or other application information, such as instant messages can cause the interrupt.

When the interrupt is detected, the user manager module 212 can associate the interrupt with a user (606). This can be based on an association with an account (e.g., calendar account, e-mail account, messaging account, etc.), or other identifying information linking the interrupt to the user. The device 200b then determines the location of the user (608). In one scenario, the device 200b attempts to detect the user using sensors. In another scenario, the device 200b can determine the location based on a prior use of the device by the user (e.g. the user is within a zone and has been allocated a portion of a presentation).

Then, at 610, the presentation module 210 provides the information associated with the interrupt to the user on a portion of the multi-user interface (e.g., an interactive display). The portion can be determined in a manner similar to methods 300 or 400. Further, if a portion is already allocated for the user, the information can be provided on the allocated portion. Further, the portion may be enlarged for the user to accommodate the additional information. At 612, method 600 comes to a stop.

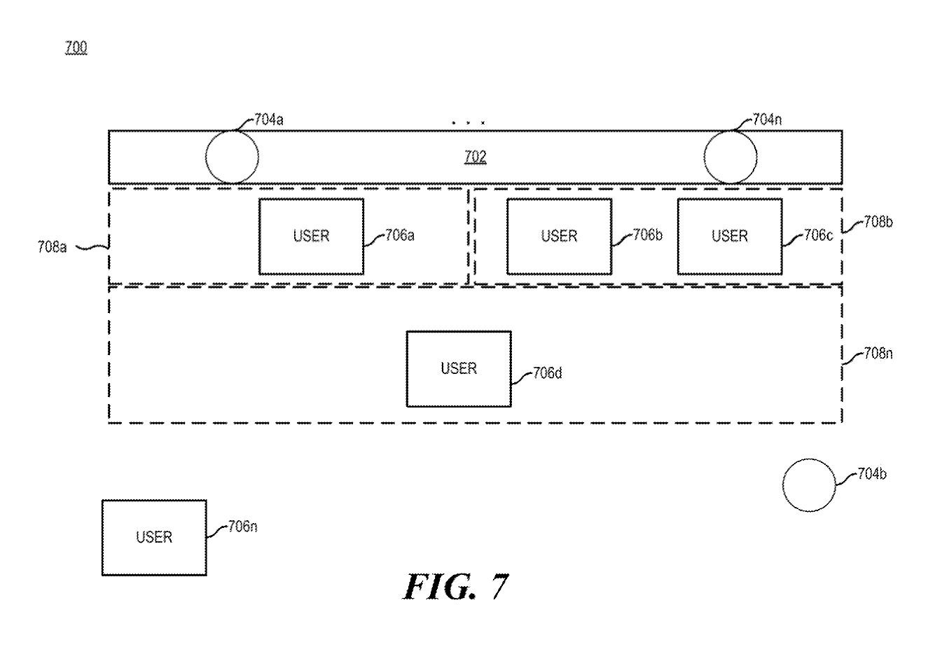

FIG. 7 is a block diagram of a system for utilizing a multi-user interactive user interface, according to one example. The system 700 includes a large interactive display 702 that can be associated with devices to provide a presentation based on position knowledge. In certain embodiments, the large interactive display 702 includes a device or computing device that can provide the presentation based on position knowledge. Sensors 704a-704n can be utilized to determine positions of users 706a-706n. Further, other information can be communicated to the large interactive display 702 to determine associated positions of users. For example, user 706n may be determined to be a user that is not within a zone that can be detected by the sensors. As such, the user 706n may be presented with an external user interface portraying information presented on the large interactive display 702.

Zones 708a-708n can be determined by the large interactive display 702. The sensors 704 can be utilized to determine zones automatically based on the surroundings. For example, the sensors 704 can detect boundaries for zones based on outer limits (e.g., edges of display, walls of a room, preset maximum range, etc.). Zones can be mapped onto these limits. Further, coordinates (e.g., two dimensional coordinates or three dimensional coordinates) can be associated with the zones. As such, the zones can be bounded. Additionally or alternatively, the zones can be set by a user and zone information can be stored in a memory associated with the large interactive display 702. In this example, three zones are shown, zones 708a-708n for explanation and clarity purposes. However, it is contemplated that additional zones can be utilized.

The sensors 704 can be utilized to detect a position of the users 706. When the position of user 706a is determined, the system can customize the user interface associated with zone 708a for user 706a. For example, because the user is close to the large interactive display 702, a touch screen interface is associated as an input type for the user 706a. Other input mechanisms may additionally be provided for the user 706a, for example, an audio interface or a gesture interface. Input settings can be based on a user profile that associates the input types with the zone the current user is within. The provisioned user interface can be a portion of the large interactive display 702 that is utilized by the user 706a. This portion of the interface can be based on the zone. For example, because zone 708a is close to the large interactive display 702, the size of the portion associated with the user 706b can be smaller so that the user may more easily view the portion. Further, scaling of user interface elements associated with the portion of the interface can be determined based on the size of the portion.

Users 706b and 706c can similarly be determined to be within zone 708b. As such, the users 706b, 706c can be provided interfaces located within zone 708b. Further, the large interactive display 702 can determine that because there are two users in the zone 708b, input mechanisms and/or portions of the display allotted to the users 706b, 706c should be augmented. In this manner, regions of the large interactive display 702 or portions of the interface that are associated with user 706b may be modified if the portion overlaps with another portion allocated to user 706c.

User 706d can be determined to be associated with zone 708n. Zone 708n is farther away from a face of the large interactive display 702 compared to zones 708a and 708b. As such, it can be determined that user 706d should be provided with a larger portion of the interface or a larger scale than the closer users. This can be, for example, accomplished by utilizing larger fonts and/or magnified images for user 706d. Additionally, the input types active for portions associated with 706d can be changed based on the zone. For example, the user 706d may be associated with a gesture interface and/or an audio interface instead of a touch screen interface. In this manner, touch inputs to the large interactive display 702 associated with the portion of the interface can be ignored based on the distance from the display of the associated user 706d.

With the above approaches, large interactive presentations can be customized for individuals. Thus, if a user is interacting with the large interactive display, content can be displayed within a field of view of the user or a field of reach of the user by utilizing location information of the user. Additionally, if important information (e.g., e-mail, messages, calendar information, etc.) associated with the user is detected; the information can be presented in a particular portion of the interface based on the location of the user. Further, as multiple users can utilize the large interactive display, it is advantageous to provide relevant information to or near respective users (e.g., a message associated with one user should not be presented to another).

What is claimed is:

1. A non-transitory computer-readable storage medium storing instructions that, if executed by a processor of a device, cause the processor to:
determine a plurality of users of a multi-user interface associated with a large interactive display;
provide a plurality of user interfaces respectively associated with the users; and
customize one of the user interfaces respectively associated with one of the users based on a location of the user.

2. The non-transitory computer-readable storage medium of claim 1, wherein an input type associated with the one user is based on the location compared to another location associated with the one user interface.

3. The non-transitory computer-readable storage medium of claim 2, further comprising instructions that, if executed by the processor, cause the processor to:
determine a zone based, at least in part, on the location,
wherein the one user interface is customized based on the zone.

4. The non-transitory computer-readable storage medium of claim 1, further comprising instructions that, if executed by the processor, cause the processor to:
associate the one user with one of a plurality of zones based on the location; and
determine that the user has changed zones to another one of the zones,
wherein the one user interface is customized based on the other one zone.

5. The non-transitory computer-readable storage medium of claim 4, wherein an input type associated with the user is determined based on the change in zones.

6. The non-transitory computer-readable storage medium of claim 5, wherein the input type includes at least one of: a touch enabled interface, a gesture interface, an audio interface, a video interface, and a remote device.

7. A device comprising:
a presentation module to present a multi-user interface associated with a large interactive display;
a user manager module to determine a plurality of users of the multi-user interface; and
a space manager module to determine a plurality of zones,
wherein one of the users is associated with a one of the zones, and
wherein a user interface portion of the multi-user interface customized for the one user is based on the one zone.

8. The device of claim 7, further comprising:
a customization module to customize an input type of the user interface portion based on the one zone.

9. The device of claim 7, further comprising:
an application manager module to determine information,
wherein the user manager module associates the information with the one user, and
wherein the presentation module determines to present the user interface portion based on the information.

10. The device of claim 9, wherein the information includes at least one of:
electronic mail information, messaging information, control information, tool panel information, property information, and calendar information.

11. The device of claim 9, further comprising:
a sensor manager module to receive sensor information associated with the one user; and
a large interactive display,
wherein the space manager module determines a focus of the one user based on the sensor information, and
wherein the presentation module presents the user interface portion on the user interface portion via the large interactive display.

12. A method comprising:
detecting a position of one user of a multi-user interactive display;
determining an orientation of the one user; and
providing a portion of the multi-user interactive display for the user as a user interface based on the position and the orientation.

13. The method of claim 12, further comprising:
detecting another position of the one user;
detecting another orientation of the one user;
determining another portion of the multi-user interactive display based on the other position and the other orientation; and
presenting the other portion to the user.

14. The method of claim 12, further comprising:
detecting another position of another user of the multi-user interactive display;
determining another orientation of the other user; and
providing another portion of the multi-user interactive display to the other user as another user interface based on the other position and the other orientation.

15. The method of claim 12, further comprising:
determining an interrupt; and
associating the interrupt with the one user,
wherein the provisioning of the portion is further based on the interrupt.
